(19) United States
(12) Patent Application Publication
(10) Pub. No.: US 2026/0218698 A1
(43) Pub. Date: Jul. 30, 2026

(54) A DIAPHRAGM COMPRESSOR ARRANGEMENT AND USE THEREOF

(71) Applicant: CAVENDISH HYDROGEN A/S, Herning (DK)

(72) Inventors: Christian Haastrup MERRILD, Avlum (DK); Harish Shankaranarayana RAO, Herning (DK)

(21) Appl. No.: 19/137,778

(22) PCT Filed: Dec. 21, 2023
(86) PCT No.: PCT/DK2023/050331

§ 371 Date: Jun. 11, 2025

(30) Foreign Application Priority Data
Dec. 22, 2022 (DK) PA202270646

(51) Int. Cl. F04B 45/053; F04B 45/04

(52) U.S. Cl. CPC F04B 45/0533; F04B 45/04

(57) ABSTRACT

A diaphragm compressor arrangement having two or more diaphragm compressors each including a diaphragm arranged between a hydraulic fluid chamber and a gas chamber, the arrangement further including a drive arrangement having first and second cylinders, each including a piston and a first piston chamber, where a piston rod extends from the piston through the first piston chamber and out through a piston rod hole and where each of the cylinders has a second piston chamber formed on an opposite side of the piston in relation to the first piston chamber, he drive arrangement including drive means connected to the piston rod of the first and second cylinders, where the drive means is arranged to reciprocate the pistons in the first cylinder and the second cylinder synchronously, where the first piston chamber of the first and second cylinders is in fluid communication with the hydraulic fluid chamber of one or more of the diaphragm compressors, where the second piston chamber of the first and second cylinders is in fluid communication with the hydraulic fluid chamber of one or more other diaphragm compressors, and the first and second cylinders comprise a guide rod extending from the piston, through the second piston chamber and out through a guide rod hole in a guide rod end of the second piston chamber.

### TECHNICAL FIELD

The disclosure relates to a diaphragm compressor arrangement comprising two or more diaphragm compressors each including a diaphragm arranged between a hydraulic fluid chamber and a gas chamber. The diaphragm compressor arrangement further includes a drive arrangement comprising a first cylinder and a second cylinder. The disclosure further relates to use of a diaphragm compressor arrangement.

### BACKGROUND

A diaphragm compressor is a variant of the classic reciprocating compressor where the compression of gas occurs by means of a flexible diaphragm (also called a membrane), instead of an intake element. The back and forth moving diaphragm is typically driven by a rod and a crankshaft mechanism so that only the diaphragm and the compressor box come in touch with pumped gas. For this reason, this construction is the particularly suited for pumping e.g. explosive gases. However, the traditional diaphragm compressor has some drawbacks in relation to vibrations and difficulties in up-scaling.

Diaphragm compressors are therefore known in many different forms and e.g. from Chinese utility model No. CN101408168A it is known to form a double-acting two stage diaphragm compressor with two cylinders each having oil cavities with different size to each drive two diaphragm compressors having different size corresponding to the different oil cavities to create a low pressure stage and a high pressure stage. However, such a two-stage diaphragm compressor design is complex and space consuming.

The disclosure therefore provides for an advantageous diaphragm compressor arrangement.

### BRIEF SUMMARY

The disclosure relates to a diaphragm compressor arrangement comprising two or more diaphragm compressors each including a diaphragm arranged between a hydraulic fluid chamber and a gas chamber. The diaphragm compressor arrangement further includes a drive arrangement comprising a first cylinder and a second cylinder, wherein each of the first and second cylinders comprises a piston and a first piston chamber, wherein a piston rod is extending from the piston, through the first piston chamber, and out through a piston rod hole in an piston rod end of the first piston chamber and wherein each of the first and second cylinders comprises a second piston chamber formed on an opposite side of the piston in relation to the first piston chamber. The drive arrangement also comprises drive means connected to the piston rod of the first and second cylinders, and wherein the drive means are arranged to reciprocate the pistons in the first cylinder and the second cylinder synchronously. The first piston chamber of the first cylinder and the second cylinder are in fluid communication with the hydraulic fluid chamber of one or more of the two or more diaphragm compressors, wherein the second piston chamber of the first cylinder and the second cylinder are in fluid communication with the hydraulic fluid chamber of one or more other diaphragm compressors of the two or more diaphragm compressors. The first and second cylinders comprise a guide rod extending from the piston, through the second piston chamber and out through a guide rod hole in a guide rod end of the second piston chamber.

Driving the diaphragm compressor arrangement by means of two cylinders connected to the same drive means is advantageous in that the two cylinders enable a more balanced and uniform load on the drive means hereby reducing stress, wear, and vibrations. Furthermore, connecting the first piston chamber of the first and second cylinders to the hydraulic fluid chamber of one or more diaphragm compressors, and connecting the second piston chamber of the first and second cylinders to the hydraulic fluid chamber of one or more other diaphragm compressors is advantageous in that thereby both the backwards and the forwards motion of the piston in the cylinders can be used for driving a diaphragm compressor thereby reducing cost, increasing overall capacity and enabling a more compact design.

Also, providing both cylinders with a guide rod extending from the piston and out of the cylinder in the opposite direction of the piston rod is advantageous in that this provide better and more linear guidance of the piston in the cylinder, hereby enabling a better seal between the piston and the cylinder and thereby reducing pressure loss and leakage across the piston. Furthermore, the piston typically comprises sealing means-e.g. in the form of gaskets, O-rings and/or other-and by supporting the piston in both ends of the cylinder the piston is better supported and the life of the seal is thereby prolonged.

In this context the term “drive means” refers to any kind of drive suited for reciprocating the pistons in two cylinders synchronously. I.e. the term includes any kind of motor driven crankshaft, motor driven camshaft and spring arrangement, any kind of rotating disk or arm arrangement or other.

In an aspect of the disclosure, a piston rod diameter of the piston rod is substantially equal to a guide rod diameter of the guide rod.

Forming the piston rod with the same diameter as the guide rod throughout the extend of the rods in the cylinders ensures that the cylinder volume hereby is substantially identical on both sides of the piston-i.e. in both stoke directions-and in that the effective piston area hereby is substantially identical on both sides of the piston. This is advantageous in that both cylinders hereby deliver the same fluid amount at the same pressure no matter the stroke direction and this enables that the diaphragm compressors-and any tubing or other between the cylinders and the diaphragm compressors-can be formed identical. This is advantageous in that this reduces the number of unique parts thereby reducing assembly cost, handling cost, maintenance cost and it reduces assembly time. Furthermore, the identical cylinder volumes on both sides of the piston ensures a more uniform and balanced operation of the diaphragm compressor arrangement and a uniform output from all diaphragm compressors.

In an aspect of the disclosure, the first piston chamber of the first cylinder is in fluid communication with the hydraulic fluid chamber of a first diaphragm compressor of the two or more diaphragm compressors, the second piston chamber of the first cylinder is in fluid communication with the hydraulic fluid chamber of a second diaphragm compressor of the two or more diaphragm compressors, the first piston chamber of the second cylinder is in fluid communication with the hydraulic fluid chamber of a third diaphragm compressor of the two or more diaphragm compressors and the second piston chamber of the second cylinder is in fluid communication with the hydraulic fluid chamber of a fourth diaphragm compressor of the two or more diaphragm compressors.

Connecting each of the piston chamber of each of the cylinders to their own individual diaphragm compressor is advantageous in that this enables a simple and efficient compressor design in which all the diaphragm compressors and tubing between the piston chambers and the diaphragm compressors can be formed identical -hereby reducing assembly cost, handling cost, maintenance cost and it reduces assembly time.

In an aspect of the disclosure, the first piston chamber of the first cylinder and the second cylinder is in fluid communication with the hydraulic fluid chamber of a first diaphragm compressor of the two or more diaphragm compressors, and wherein the second piston chamber of the first cylinder and the second cylinder is in fluid communication with the hydraulic fluid chamber of a second diaphragm compressor of the two or more diaphragm compressors.

Connecting the first piston chamber of the first and second cylinders to the hydraulic fluid chamber of the same first diaphragm compressor and connecting the second piston chamber of the first and second cylinders to the same second diaphragm compressor is advantageous in that hereby the number of compressors can be reduced—thus, reducing cost, complexity and increasing compactness.

In an aspect of the disclosure, the first piston chamber of the first cylinder is in fluid communication with the hydraulic fluid chamber of one or more of the two or more diaphragm compressors through a first tubing and the first piston chamber of the second cylinder is in fluid communication with the hydraulic fluid chamber of one or more of the two or more diaphragm compressors through a second tubing. The second piston chamber of the first cylinder is in fluid communication with the hydraulic fluid chamber of the one or more other diaphragm compressors of the two or more diaphragm compressors through a third tubing and the second piston chamber of the second cylinder is in fluid communication with the hydraulic fluid chamber of the one or more other diaphragm compressors of the two or more diaphragm compressors through a fourth tubing.

Enabling fluid communication between the piston chambers of the cylinders and the hydraulic fluid chamber of the diaphragm compressors through dedicated tubing is advantageous in that this enables simple means for forming the relative complex fluid communication.

In an aspect of the disclosure, the first cylinder and the second cylinder are parallel.

Arranging the first cylinder and the second cylinder to be parallel is advantageous in that this generates a more balanced operation in which the synchronized operation of the pistons in the two cylinders will counteract each other and generate less stress and vibrations.

In an aspect of the disclosure, the first cylinder and the second cylinder are arranged on opposite sides of the drive means.

Arranging the cylinders on opposite sides of the drive means is advantageous in that the load of the two cylinders hereby will act in opposite directions on the drive means and thereby generate a more balanced load which will prolong the life of the drive means—particularly of any bearings guiding the rotary motion of the drive means. Furthermore, a more compact design of the diaphragm compressor arrangement is enabled by arranging the cylinders on opposite sides of the drive means.

In an aspect of the disclosure, the diaphragm compressor arrangement is a high-pressure diaphragm compressor arrangement arranged for pressurizing a gas in the gas chamber of the two or more diaphragm compressors to a pressure between 10 and 300 MPa, preferably between 20 and 200 MPa, and most preferred between 30 and 130 MPa.

If the pressure is too low the capacity of the diaphragm compressor arrangement is too low and if the pressure is too high the risk of leakage or damage increases. Thus, the present pressure ranges present an advantageous relationship between efficiently and function. Furthermore, it should be noted that the present disclosure is particularly advantageous in relation to high-pressure diaphragm compressor arrangement operating in the present pressure ranges in that one chamber of two cylinders connected to a single diaphragm compressor is particularly suited for generating a high pressure.

In an aspect of the disclosure, the drive means are arranged to reciprocate the pistons in the first cylinder and the second cylinder at least 300 times per minute.

If the drive means are too slow the capacity of the diaphragm compressor arrangement is too low, and it is therefore advantageous that the drive means reciprocate the pistons in the cylinders at least 300 times per minute.

In an aspect of the disclosure, the two or more diaphragm compressors are substantially identical.

Forming the diaphragm compressors so that they are substantially identical is advantageous in that this reduces the complexity of the diaphragm compressor arrangement, and it reduces the number of unique needed to build and maintain the diaphragm compressor arrangement.

In an aspect of the disclosure, the drive means are arranged to reciprocate the pistons in the first cylinder and the second cylinder synchronously between a first cylinder end and a second cylinder end of the cylinders so that a maximum volume and a minimum volume of the first piston chamber and the second piston chamber are substantially identical in each cylinder.

Forming the first piston chamber and the second piston chamber in the two cylinders and making the pistons reciprocate so that the maximum volume and the minimum volume of the first piston chamber and the second piston chamber are substantially identical in both cylinder is advantageous in that this symmetrical design ensures a more uniform and symmetrical load on the cylinders, the drive means and the diaphragm compressor ensuring longer life and a more stable and vibrationless operation of the diaphragm compressor arrangement.

In an aspect of the disclosure, the drive means are arranged to reciprocate the pistons in the first cylinder and the second cylinder so that the pistons travel in opposite directions.

Arranging the drive means so that the pistons at all times travel in opposite directions—i.e. either against each other or away from each other—is advantageous in that this provides a more balanced and uniform load on the bearings of the crankshaft throughout the full rotation of the crankshaft—e.g. prolonging the life of the bearings—and so that the motion of the pistons cancels each other out to thereby reduce vibrations generated by the drive arrangement and the pistons.

In an aspect of the disclosure, the hydraulic fluid is a liquid, such as hydraulic oil Using liquid, such as hydraulic oil, as the hydraulic fluid in the diaphragm compressor arrangement according to present disclosure is advantageous in that liquids, such as hydraulic oil, are non-compressible, have good thermal capacity and conductivity, have a good lubrication effect and other qualities that that make liquids superior to gasses as hydraulic fluid in a diaphragm compressor arrangement.

In an aspect of the disclosure, the diaphragm of the two or more diaphragm compressors comprises one or more diaphragm layers of which at least one is made of metal.

Forming the diaphragm of metal-such as nickel, steel, stainless steel, aluminum, titanium, another metal or an alloy of these metals or any combination thereof-is advantageous in that metal is impermeable to gasses and particularly impermeable to hydrogen making the diaphragm compressor arrangement more efficient. Furthermore, metal diaphragms are durable and can stand high pressures and high temperatures making metal diaphragms particularly suited when compressing gasses such as hydrogen.

The disclosure further relates to use of a diaphragm compressor arrangement in a hydrogen fueling station.

Using the diaphragm compressor arrangement according to the present disclosure in a hydrogen fueling station is particularly advantageous in that in hydrogen fueling stations compactness is important due to the limited space and high efficiency is advantageous in that in that this will speed up the fueling process.

### BRIEF DESCRIPTION OF THE DRAWINGS

For a more complete understanding of this disclosure, reference is now made to the following brief description, taken in connection with the accompanying drawings and detailed description, wherein like reference numerals represent like parts. The figures all illustrate exemplary embodiments of the disclosure:

FIG. 1 illustrates a simplified representation of a diaphragm compressor arrangement comprising two diaphragm compressors, and

FIG. 2 illustrates a simplified representation of a diaphragm compressor arrangement comprising four diaphragm compressors.

### DETAILED DESCRIPTION

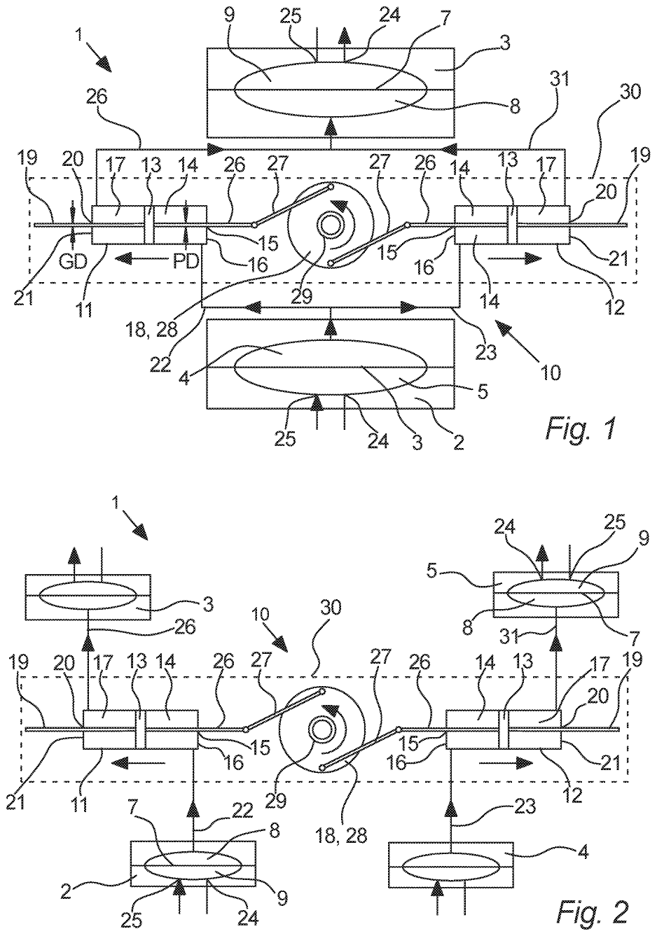

FIG. 1 illustrates a simplified representation of a diaphragm compressor arrangement 1 comprising two diaphragm compressors 2, 3.

In this embodiment the diaphragm compressor arrangement 1 comprises two diaphragm compressors 2, 3 each including a diaphragm 7 arranged between a hydraulic fluid chamber 8 and a gas chamber 9. I.e. in this embodiment the compressors 2, 3 are arranged to compress a gas in the gas chambers 9 when the diaphragms 7 are pushed towards the gas chambers 9 by a hydraulic fluid entering and expanding the hydraulic fluid chambers 8. Once the gas in the gas chambers 9 have been compressed it leaves the diaphragm compressors 2, 3 through an exit port 24 and when the hydraulic fluid is sucked out of the hydraulic fluid chambers 8, the exit ports 24 closes and gas to be compressed is drawn into the gas chambers 9 through inlet ports 25. To ensure that gas only can travel in the correct direction through the inlet ports 25 and the exit ports 24 the ports 24, 25 are provided with check valves (not shown).

In this embodiment the gas compressed by the diaphragm compressors 2, 3 is hydrogen but in another embodiment the gas could be methane, oxygen or another gas.

In this embodiment the diaphragm compressor arrangement 1 also comprises a drive arrangement 10 comprising a first cylinder 11 and a second cylinder 12, wherein the first cylinder 11 and the second cylinder 12 in this embodiment are substantially identical. The cylinders 11, 12 are arranged for displacing the hydraulic fluid to and from the hydraulic fluid chambers 8 and thereby drive the compression process in the diaphragm compressors 2, 3. In this embodiment each of the cylinders 11, 12 comprises a piston 13 arranged to travel back and forth in the cylinders 11, 12 to thereby alter the volume of a first piston chamber 14 and a second piston chamber 17 formed on opposite sides of the piston 13 inside the cylinders 11, 12. In this embodiment the travel of the piston 13 is enabled by a piston rod 6 connected to the piston 13 and the piston rod 6 is extending from the piston 13, through the first piston chamber 14, and out through a piston rod hole 15 formed in an piston rod end 16 of the first piston chamber 14.

In this embodiment the piston 13 in both the first cylinder 11 and the second cylinder 12 travels back and forth in the cylinders 11, 12 so that the maximum volume and the minimum volume of the first piston chamber 14 and the second piston chamber 17 are substantially identical so that both cylinders 11, 12 at all times displace substantially the same amount of hydraulic fluid to and from the respective hydraulic fluid chambers 4, 8. I.e., in this embodiment the drive means 18 are arranged to reciprocate the pistons 13 in the first cylinder 11 and the second cylinder 12 synchronously between a first cylinder end and a second cylinder end of the cylinders 11, 12 so that a maximum volume and a minimum volume of the first piston chamber 14 and the second piston chamber 17 are substantially identical in each cylinder 11, 12. However, in another embodiment the maximum volume and/or the minimum volume of the first piston chamber 14 could be different from the corresponding volume of the second piston chamber 17 if an asynchronous displacement was desired.

In this embodiment the piston rods 26 from both cylinders 11, 12 are connected to the same drive means 18 of the drive arrangement 10 by means of connection arms 27. In this embodiment the drive means 18 comprises a crankshaft 28 being rotated by a motor (not shown)—in this case an electrical motor—but in another embodiment the drive means 18 could also or instead comprise other means for generating the reciprocating motion of the pistons 13 in the cylinders 11, 12—such as a cam or camshaft and spring arrangement or similar known to the skilled person.

In this embodiment the connection arms 27 are connected to opposite sides of the crankshaft 28—i.e. 180° displaced—so that when the crankshaft 28 rotates, it will reciprocate the pistons 13 in the first cylinder 11 and second cylinder 12 synchronously and so that the pistons 13 at all times travel in opposite directions—i.e. either against each other or away from each other—whereby they subject the bearings 29 of the crankshaft 28 to a more balanced and uniform load throughout the full rotation of the crankshaft 28—e.g. prolonging the life of the bearings 29—and so that the motion of the pistons 13 cancels each other out to thereby reduce vibrations generated by the drive arrangement 10.

In this embodiment the drive arrangement 10 is formed in a drive arrangement housing 30 formed separate from the two diaphragm compressors 2, 3 and in this embodiment the first piston chamber 14 of the first cylinder 11 is in fluid communication with the hydraulic fluid chamber 8 of a first diaphragm compressor 2 through a first tubing 22, the first piston chamber 14 of the second cylinder 12 is in fluid communication with the hydraulic fluid chamber 8 of the first diaphragm compressors 2 through a second tubing 23, the second piston chamber 17 of the first cylinder 11 is in fluid communication with the hydraulic fluid chamber 8 a second diaphragm compressor 3 through a third tubing 26 and the second piston chamber 17 of the second cylinder 12 is in fluid communication with the hydraulic fluid chamber 8 of the second diaphragm compressor 3 through a fourth tubing 31. In this embodiment the tubing 22, 23 comprises fittings, manifolds, and pipes but in another embodiment the tubing 22, 23 could also or instead comprise valves, filters, pressure gauges and other.

Typically the cylinders 11, 12 and the diaphragm compressors (2, 3, 4, 5) are formed in the same block or housing and the fluid communication between the piston chambers 14, 17 and the hydraulic fluid chambers 8 are established by means of conduits formed internally in the block or housing—e.g., by drilling or casting channels in the block or housing. However, given the more complex system with merging fluid channels and the utilization of the chambers 14, 17 on both sides of the piston 13 in the present disclosure it is advantageous to connect the cylinders 11, 12 to the diaphragm compressors 2, 3 through dedicated tubing 22, 23, 26, 31 in this embodiment. Furthermore, this enables that the diaphragm compressors 2, 3 and the drive arrangement 10 may be manufactured, stored and handled in separate processes thereby reducing cost and increasing flexibility. However, in another embodiment the fluid communication between the piston chambers 14, 17 and the hydraulic fluid chambers 8 would be established by means of conduits formed internally in the block or housing to avoid tubing 22, 23, 26, 31—e.g., due to problems in forming the tubing 22, 23, 26, 31 leak tight due to the high hydraulic fluid pressure.

In this embodiment the first cylinder 11 and the second cylinder 12 are arranged to be parallel and coaxial on opposite sides of the drive means 18. However, in another embodiment the cylinders 11, 12 could be arranged parallel on the same side of the drive means 18 with the center axis displaced, the cylinders 11, 12 could be arranged parallel with the center axis displaced on opposite sides of the drive means 18, the cylinders 11, 12 could be arranged slanting on the same side or on opposite sides of the drive means 18 with the center axis crossed and/or in another embodiment the drive arrangement 10 could comprise more than two cylinders 11, 12—such as three, four, six or even more.

In this embodiment the first and second cylinders 11, 12 further comprise a guide rod 19 connected to the piston 13 and extending from the piston 13, through the second piston chamber 17, and out through a guide rod hole 20 in a guide rod end 21 of the second piston chamber 17, wherein the guide rod end 21 is arranged in the opposite end of the cylinders 11, 12 in relation to the piston rod end 16. And in this embodiment the piston rod diameter PD of the piston rod 6 is substantially equal to the guide rod diameter GD of the guide rod 19 throughout the extend of the rods 19, 26 inside the cylinders 11, 12 so that the total cylinder volume of the first piston chambers 14 of the cylinders 11, 12 is substantially identical to the total cylinder volume of the second piston chambers 17 of the cylinders 11, 12. However, in another embodiment the piston rod diameter PD could be different from the guide rod diameter GD—e.g., if different volumes and pressures was desired. The holes 15, 20 in the ends of the cylinders 11, 12 are obviously provided with sealing means (not shown) to ensure that the pressurized hydraulic fluid does not escape the cylinders 11, 12 through the holes 15, 20.

Forming the cylinders 11, 12 with a guide rod 19 is advantageous in that the piston 13 hereby is suspended in both ends of the cylinders 11, 13 whereby the piston 13 is less affected by the torque the piston rod 6 is subject to by the drive means 18—particularly rotating drive means 18—and the risk of leakage across the piston 13 from one chamber 14, 17 to the other is reduced. Furthermore, by forming the guide rod 19 effectively identical to the piston rod 6, the total cylinder volume of the first piston chambers 14 are substantially identical to the total cylinder volume of the second piston chambers 17, whereby the first diaphragm compressor 2 can be identical to the second diaphragm compressor 3—as in this embodiment. This is advantageous in that the tubing 22, 23, 26, 31 hereby also can be formed identical and this mirrored setup means that the diaphragm compressor arrangement 1 can be built by means of fewer unique parts—hereby reducing manufacturing costs—and the diaphragm compressor arrangement 1 is hereby easier to build, handle, maintain etc. Furthermore, this setup also means that the output of the diaphragm compressors 2, 3 is substantially identical in volume and pressure and the output of both diaphragm compressors 2, 3 can hereby be guided to the same compressed gas storage vessel thereby further reducing complexity and cost.

However, in another embodiment the piston rod diameter PD of the piston rod 6 could be different from the guide rod diameter GD of the guide rod 19 so that the total cylinder volume of the first piston chambers 14 of the cylinders 11, 12 would be different from the total cylinder volume of the second piston chambers 17 of the cylinders 11, 12—and for the same reason the effective surface of the piston 13 is different in the second piston chamber 17 and the first piston chamber 14 leading to difference in the generated gas pressure. I.e. in another embodiment the hydraulic fluid volume delivered to the two hydraulic fluid chambers 8 is different per full back and forth movement of the pistons 13 and the given the difference in effective surface of the pistons 13 in the two piston chambers 14, 17, the pressure is also different. Thus, a difference in the total cylinder volumes and pressures could be advantageous if a two-stage diaphragm compressor arrangement 1 was desired or if it was desired that the diaphragm compressor arrangement 1 could supply two different sources with gas at different volumes and/or pressure.

In this embodiment the hydraulic fluid is a liquid in the form of hydraulic oil but in another embodiment the hydraulic fluid could be canola oil, glycol, paraffin oil or another liquid suited for use as a hydraulic fluid in a diaphragm compressor arrangement 1.

FIG. 2 illustrates a simplified representation of a diaphragm compressor arrangement 1 comprising four diaphragm compressors 2, 3, 4, 5.

In this embodiment each of the piston chambers 14, 17 of each of the cylinders 11, 12 are connected to their own individually diaphragm compressors 2, 3, 4, 5. I.e. in this embodiment first piston chamber 14 of the first cylinder 11 is in fluid communication with the hydraulic fluid chamber 8 of the first diaphragm compressor 2, the second piston chamber 17 of the first cylinder 11 is in fluid communication with the hydraulic fluid chamber 8 of the second diaphragm compressor 3, the first piston chamber 14 of the second cylinder 12 is in fluid communication with the hydraulic fluid chamber 8 of the third diaphragm compressor 4, and the second piston chamber 17 of the second cylinder 12 is in fluid communication with the hydraulic fluid chamber 8 of the fourth diaphragm compressor 5.

In this embodiment the guide rod 19 is effectively identical to the piston rod 6 inside the piston chambers 14, 17 and in this embodiment the volume of the hydraulic fluid chambers 8 of all the diaphragm compressors 2, 3, 4, 5 substantially corresponds to the cylinder volume of each of the piston chambers 14, 17 of the first cylinder and the second cylinder which in turn means that in this embodiment the four diaphragm compressors 2, 3, 4, 5 are substantially identical. Thus, in this embodiment the output from all diaphragm compressors 2, 3, 4, 5 is guided to the same compressed gas storage vessel (not shown) but in another embodiment two or more diaphragm compressors 2, 3, 4, 5 could supply pressurized gas to different sources.

Forming the hydraulic fluid chambers so that their volumes substantially correspond to the volumes of the piston chambers to which they are in fluid communication with is advantageous in that the full capacity of the diaphragm compressors can hereby be better utilized and it should be noted that “substantially correspond” in this embodiment refers to that the cylinder volume of the piston chambers typically is a few percent larger than the volume of the corresponding hydraulic fluid chamber to compensate for any elastic compression of the hydraulic fluid.

In this embodiment the diaphragm compressor arrangement 1 is a single stage high-pressure diaphragm compressor arrangement 1 arranged for raising the pressure of the gas in the gas chambers 9 from a pressure around 40 MPa to a pressure around 90 MPa. However, in another embodiment the starting pressure of the gas could be lower—such as 30 MPa, 15 MPa, 5 MPa or even lower—or the starting pressure of the gas could be higher—such as 50 MPa, 60 MPa, 80 MPa or even higher. And/or in another embodiment the pressure could be raised less—such as to 80 MPa, 70 MPa, 50 MPa or even less—or the pressure could be raised more—such as to 100 MPa, 130 MPa, 160 MPa or even more.

In this embodiment the drive means 18 are arranged to reciprocate the pistons 13 in the first cylinder 11 and the second cylinder 12 at least 300 times per minute to ensure a high capacity of the diaphragm compressor arrangement 1. However, in another embodiment the drive means 18 could be arranged to reciprocate the pistons 13 less—such as at least 250, 150, 50 times per minute or even less—or the drive means 18 could be arranged to reciprocate the pistons 13 more—such as at least 400, 600, 1,000 times per minute or even more—e.g. depending on the specific capacity of the diaphragm compressor arrangement 1, the specific gas or hydraulic fluid, the specific use or other and/or the drive means 18 could be controlled to reciprocate the pistons 13 in the first cylinder 11 and the second cylinder 12 a variable times per minute e.g. in dependency with a specific desired variable output of the diaphragm compressor arrangement 1, in dependency of one or more operation parameters such as temperature of hydraulic fluid, gas or other, time to maintenance, noise level or other.

In this embodiment the diaphragm compressor arrangement 1 is used for compressing hydrogen in a hydrogen fueling station (not shown). I.e. in this embodiment the diaphragm compressor arrangement 1 is used for raising the pressure of hydrogen being delivered to a hydrogen fueling station before it is stored in a storage vessel (not shown). However, in another embodiment the diaphragm compressor arrangement 1 could be used for raising the pressure of hydrogen during a fueling process, for maintaining the pressure in a storage vessel or in another process in a hydrogen fueling station. However, in another embodiment the diaphragm compressor arrangement 1 according to the present disclosure could is used for compressing another type of gas and/or be used in relation to other processes—such as in a gas manufacturing or storing process, in an industrial facility or other.

In this embodiment the diaphragms 7 in the diaphragm compressors 2, 3, 4, 5 are illustrated by a single line. However, in most actual embodiments the diaphragms 7 would be formed by more than one layer such as two, three, four or even more layers.

The disclosure has been exemplified above with reference to specific examples of diaphragm compressor 2, 3, 4, 5, cylinders 11, 12, drive means 18 and other. However, it should be understood that the disclosure is not limited to the particular examples described above but may be designed and altered in a multitude of varieties within the scope of the disclosure as specified in the claims.

1. A diaphragm compressor arrangement comprising,
two or more diaphragm compressors each including a diaphragm arranged between a hydraulic fluid chamber and a gas chamber
a drive arrangement comprising a first cylinder and a second cylinder wherein each of said first and second cylinders comprises a piston and a first piston chamber wherein a piston rod is extending from said piston through said first piston chamber, and out through a piston rod hole in an piston rod end of said first piston chamber and wherein each of said first and second cylinders comprises a second piston chamber formed on an opposite side of said piston in relation to said first piston chamber
wherein said drive arrangement comprises a drive connected to said piston rod of said first and second cylinders, and wherein said drive means areis arranged to reciprocate said pistons in said first cylinder and said second cylinder synchronously, and
wherein said first piston chamber of said first cylinder and said second cylinder are in fluid communication with said hydraulic fluid chamber of one or more of said two or more diaphragm compressors wherein said second piston chamber of said first cylinder and said second cylinder are in fluid communication with said hydraulic fluid chamber of one or more other diaphragm compressors of said two or more diaphragm compressors and
wherein said first and second cylinders comprise a guide rod extending from said piston through said second piston chamber and out through a guide rod hole in a guide rod end of said second piston chamber.

2. The diaphragm compressor arrangement according to claim 1, wherein a piston rod diameter of said piston rod is substantially equal to a guide rod diameter of said guide rod.

3. The diaphragm compressor arrangement according to claim 1 or 2, wherein said first piston chamber of said first cylinder is in fluid communication with said hydraulic fluid chamber of a first diaphragm compressor of said two or more diaphragm compressors wherein said second piston chamber of said first cylinder is in fluid communication with said hydraulic fluid chamber of a second diaphragm compressor of said two or more diaphragm compressors wherein said first piston chamber of said second cylinder is in fluid communication with said hydraulic fluid chamber of a third diaphragm compressor of said two or more diaphragm compressors and wherein said second piston chamber of said second cylinder is in fluid communication with said hydraulic fluid chamber of a fourth diaphragm compressor of said two or more diaphragm compressors.

4. The diaphragm compressor arrangement according to claims 1 or 2, wherein said first piston chamber of said first cylinder and said second cylinder is in fluid communication with said hydraulic fluid chamber of a first diaphragm compressor of said two or more diaphragm compressors and wherein said second piston chamber of said first cylinder and said second cylinder is in fluid communication with said hydraulic fluid chamber of a second diaphragm compressor of said two or more diaphragm compressors.

5. The diaphragm compressor arrangement according to claim 1, wherein said first piston chamber of said first cylinder is in fluid communication with said hydraulic fluid chamber of one or more of said two or more diaphragm compressors through a first tubing said first piston chamber of said second cylinder is in fluid communication with said hydraulic fluid chamber of one or more of said two or more diaphragm compressors through a second tubing said second piston chamber of said first cylinder is in fluid communication with said hydraulic fluid chamber of said one or more other diaphragm compressors of said two or more diaphragm, compressors through a third tubing and said second piston chamber of said second cylinder is in fluid communication with said hydraulic fluid chamber of said one or more other diaphragm compressors of said two or more diaphragm compressors through a fourth tubing.

6. The diaphragm compressor arrangement according to claim 1, wherein said first cylinder and said second cylinder are parallel.

7. The diaphragm compressor arrangement according to the preceding claims 1, wherein said first cylinder and said second cylinder are arranged on opposite sides of said drive.

8. The diaphragm compressor arrangement according to the preceding eclaims 1, wherein said diaphragm compressor arrangement is a high-pressure diaphragm compressor arrangement arranged for pressurising a gas in said gas chamber of said two or more diaphragm compressors to a pressure between 10 and 300 MPa.

9. The diaphragm compressor arrangement according to claim 1, wherein said drive is arranged to reciprocate said pistons in said first cylinder and said second cylinder at least 300 times per minute.

10. The diaphragm compressor arrangement according to claim 1, wherein said two or more diaphragm compressors are substantially identical.

11. The diaphragm compressor arrangement according to claim 1, wherein said drive is arranged to reciprocate said pistons in said first cylinder and said second cylinder synchronously between a first cylinder end and a second cylinder end of said cylinders so that a maximum volume and a minimum volume of said first piston chamber and said second piston chamber are substantially identical in each cylinder.

12. The diaphragm compressor arrangement according to claim 1, wherein said drive means is arranged to reciprocate said pistons in said first cylinder and said second cylinder so that said pistons travel in opposite directions.

13. The diaphragm compressor arrangement according to claim 1, wherein said hydraulic fluid is a liquid, such as hydraulic oil.

14. The diaphragm compressor arrangement according to any claim 1, wherein said diaphragm of said two or more diaphragm compressors comprises one or more diaphragm layers of which at least one is made of metal.

15. The diaphragm compressor arrangement according to claim 1 disposed in a hydrogen fuelling station.
